(19) United States
(12) Patent Application Publication
(10) Pub. No.: US 2022/0020509 A1
(43) Pub. Date: Jan. 20, 2022

(54) CONDUCTIVE POLYMER MICROFIBER MESH STRUCTURE, MANUFACTURING METHOD THEREOF AND ELECTRODE FOR FLEXIBLE ELECTRONIC DEVICE USING THE SAME

(71) Applicant: GWANGJU INSTITUTE OF SCIENCE AND TECHNOLOGY, Gwangju (KR)

(72) Inventors: Myung-Han YOON, Gwangju (KR); Youngseok KIM, Gwangju (KR); Jiwoong KIM, Gwangju (KR)

(21) Appl. No.: 17/377,553

(22) Filed: Jul. 16, 2021

(30) Foreign Application Priority Data
Jul. 17, 2020 (KR) 10-2020-0089073

(51) Int. Cl. H01B 1/12; D04H 3/007; D04H 3/14; D04H 3/03

(52) U.S. Cl. CPC H01B 1/124; D04H 3/007; D10B 2321/121; D04H 3/03; D10B 2401/16; D04H 3/14

(57) ABSTRACT

Proposed is a conductive polymer microfiber mesh structure including a plurality of conductive polymer microfibers, in which any one of the conductive polymer microfibers intersects at least one or more other conductive polymer microfibers, and intersections share crystallinity without a specific crosslinking agent and are structurally fused, whereby a mesh structure is formed. According to the conductive polymer microfiber mesh structure, it is possible to provide a conductive polymer microfiber mesh structure that has elasticity, flexibility, and transmittance, is structurally stable, and has excellent electric and electrochemical characteristics, and an electrode for a flexible electronic device using the structure and having improved physical stability and suspension stability.

### BACKGROUND OF THE INVENTION

### Field of the Invention

The present invention relates to a conductive polymer microfiber mesh structure, a manufacturing method thereof, and an electrode for flexible electronic device using the same. More particularly, the present invention relates to a conductive polymer microfiber mesh structure having a structural stability improved by structural fusion of conductive polymer microfibers without a specific crosslinking agent, a manufacturing method thereof, and an electrode for flexible electronic device using the same.

### Description of the Related Art

A flexible electronic device, which is a next-generation electronic device that can operate without losing the characteristics thereof even though a substrate is stretched or severely bent and that can keep the characteristics even though an external force is removed, is recently highlighted as a future critical technology that can be used for flexible displays, wearable electronic devices, electronic skins, or the like.

It would be required to develop first a technology of manufacturing a substrate and an electrode that are parts of a flexible device in order to implement a flexible electronic device. In particular, it is required for a flexible electronic device not only to have flexibility, elasticity, and excellent electric and electrochemical characteristics, but also to maintain structural stability.

Recently, studies about an elastic conductor for forming the electrodes and wires of electronic devices are mainly conducted. However, an electrode made of an elastic conductor for a flexible electronic device of the related art has flexibility and elasticity, but has a limitation that the structural stability is poor.

### CITATION LIST

### Patent Literature

Patent Literature 1: Korean Patent Application Publication No. 10-2019-0071489

### SUMMARY OF THE INVENTION

An object of the present invention is to provide a conductive polymer microfiber mesh structure that has elasticity, flexibility, transmittance, excellent electric and electrochemical characteristics, and improved structural stability, a manufacturing method thereof, and an electrode for flexible electronic device using the same.

The objectives to implement in the present invention are not limited to the technical problems described above and other objects that are not stated herein will be clearly understood by those skilled in the art from the following specifications.

In order to achieve the objects, an embodiment of the present invention provides a conductive polymer microfiber mesh structure.

A conductive polymer microfiber mesh structure according to an embodiment of the present invention includes a plurality of conductive polymer microfibers, in which any one of the conductive polymer microfibers intersects at least one or more other conductive polymer microfibers, and intersections share crystallinity without a specific crosslinking agent and are structurally fused, whereby a mesh structure is formed.

The crystallinity of the conductive polymer microfiber may be improved by post treatment using a solution containing acid and a polar solvent.

The conductive polymer microfiber may have a cylindrical corpuscular shape.

The conductive polymer microfibers may be made of a conductive polymer having a pi-orbital.

For example, the conductive polymer having a pi-orbital may include at least any one selected from a group consisting of polyacetylene, polyphenylene, polythiophene, polypyrrole, polyaniline, and poly(3,4-ethylenedioxythiophene).

In order to achieve the objects, another embodiment of the present invention provides an electrode comprising the conductive polymer microfiber mesh structure according to an embodiment of the present invention.

In order to achieve the objects, another embodiment of the present invention provides a flexible electrode device including the electrode including the conductive polymer microfiber mesh structure according to an embodiment of the present invention.

In order to achieve the objects, an embodiment of the present invention provides a method of manufacturing a conductive polymer microfiber mesh structure.

The method of manufacturing a conductive polymer microfiber mesh structure according to an embodiment of the present invention includes: producing a conductive polymer solution by dissolving a conductive polymer in a solvent; performing wet-spinning on the conductive polymer solution; performing post treatment for improving crystallinity of the wet-spun conductive polymer microfiber; forming cylindrical corpuscles by cutting several times the post-treated microfiber to have a cut surface perpendicular to the longitudinal direction; removing the solvent by filtering the corpuscular conductive polymer microfiber under a vacuum state; and fusing the structure at an intersection of the corpuscles by thermally drying the corpuscular conductive polymer microfiber with the solvent removed, in which any one of the conductive polymer microfibers intersects at least one or more other conductive polymer microfibers, and intersections share crystallinity without a specific crosslinking agent and are structurally fused, whereby a mesh structure is formed.

The conductive polymer may be a conductive polymer having a pi-orbital.

For example, the conductive polymer having a pi-orbital may include at least any one selected from a group consisting of polyacetylene, polyphenylene, polythiophene, polypyrrole, polyaniline, and poly(3,4-ethylenedioxythiophene).

The solvent may include at least one selected from a group consisting of water, acetone, ethyl acetate, hexane, ether, chloroform, dichloromethane, and toluene.

The performing of post treatment for improving crystallinity may include treatment using a solution containing acid and a polar solvent.

### BRIEF DESCRIPTION OF THE DRAWINGS

FIGS. 1A-1B are microscopic pictures of a conductive polymer microfiber mesh structure according to an embodiment of the present invention;

FIG. 2 is a flowchart showing a method of manufacturing a conductive polymer microfiber mesh structure according to an embodiment of the present invention;

FIG. 3 is a graph showing suspension stability measured over time of an electrode using a conductive polymer microfiber mesh structure according to an embodiment of the present invention;

FIG. 4 is a graph showing sheet resistance measured over mass per unit area of an electrode using a conductive polymer microfiber mesh structure according to an embodiment of the present invention;

FIG. 5 is a graph showing specific capacitance per unit area measured under a 3-electrode system of an electrode using a conductive polymer microfiber mesh structure according to an embodiment of the present invention; and

FIGS. 6A-6D are pictures showing a transmittance change over mass per unit area of an electrode using a conductive polymer microfiber mesh structure according to an embodiment of the present invention.

### DETAILED DESCRIPTION OF THE PREFERRED EMBODIMENTS

Hereinafter, the present invention is described with reference to the accompanying drawings. However, the present invention may be modified in various different ways and is not limited to the embodiments described herein. Further, in the accompanying drawings, components irrelevant to the description will be omitted in order to obviously describe the present invention, and similar reference numerals will be used to describe similar components throughout the specification.

Throughout the specification, when an element is referred to as being “connected with (coupled to, combined with, in contact with)” another element, it may be “directly connected” to the other element and may also be “indirectly connected” to the other element with another element intervening therebetween. Further, unless explicitly described otherwise, “comprising” any components will be understood to imply the inclusion of other components rather than the exclusion of any other components.

Terms used in the present invention are used only in order to describe specific exemplary embodiments rather than limiting the present invention. Singular forms are intended to include plural forms unless the context clearly indicates otherwise. It will be further understood that the terms “comprises” or “have” used in this specification specify the presence of stated features, numerals, steps, operations, components, parts, or a combination thereof, but do not preclude the presence or addition of one or more other features, numerals, steps, operations, components, parts, or a combination thereof.

Hereinafter, embodiments of the present invention are described in detail with reference to the accompanying drawings.

A conductive polymer microfiber mesh structure according to an embodiment of the present invention is described.

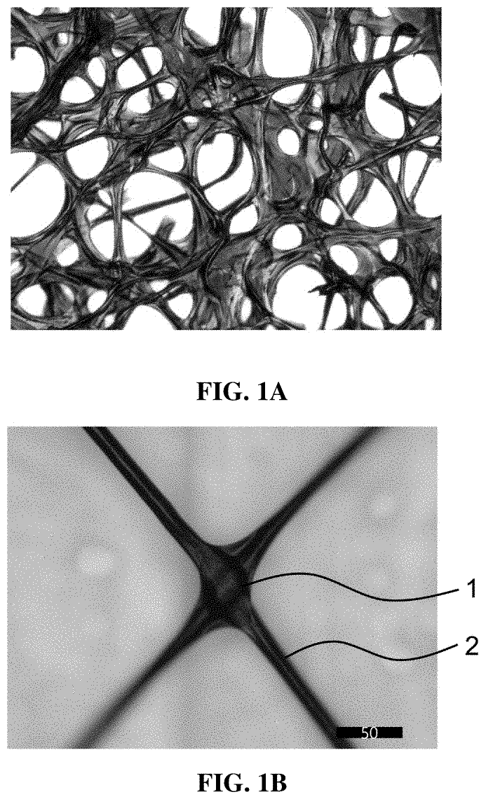

In FIGS. 1A-1B, FIG. 1A is a microscopic picture of a conductive polymer microfiber mesh structure according to an embodiment of the present invention and FIG. 1B is a picture showing an intersection of fibers in the conductive polymer microfiber mesh structure.

Referring to FIGS. 1A-1B, a conductive polymer microfiber mesh structure according to an embodiment of the present invention includes a plurality of conductive polymer microfibers 2, in which any one of the conductive polymer microfibers intersects at least one or more other conductive polymer microfibers. Further, the conductive polymer microfibers share crystallinity without a specific crosslinking agent and structural fusion occurs at an intersection 1, so the conductive polymer microfibers form a mesh structure.

In this case, the conductive polymer microfibers may be obtained by performing wet spinning directly on a conductive polymer.

In this case, the conductive polymer microfibers may be made of a conductive polymer having a pi-orbital.

In this case, the conductive polymer having a pi-orbital, which is an organic polymer having conductivity capable of conducting electricity, and may include any conductive polymer without limitation as long as it is a conductive polymer having a conjugation structure in which a C—C bond and a C═C bond alternately exist and thereby having an electrical characteristic by delocalization of electron density of π.

For example, the conductive polymer having a pi-orbital may include at least any one selected from a group consisting of polyacetylene, polyphenylene, polythiophene, polypyrrole, polyaniline, and poly(3,4-ethylenedioxythiophene).

In this case, the crystallinity of the conductive polymer microfiber may be improved by post treatment using a solution containing acid and a polar solvent. In detail, an unnecessary surfactant is removed through acid solution treatment, whereby the crystallinity may be improved. For example, the conductive polymer microfiber may be a PEDOT chain with a PSS-chain removed from PEDOT:PSS.

In this case, the conductive polymer microfiber may have cylindrical corpuscles form cut several times perpendicular to the longitudinal direction of the fiber.

Due to the characteristics of the configuration described above, conductive polymer microfibers are structurally directly fused at the intersection thereof without a specific crosslinking agent in the conductive polymer microfiber mesh structure of the present invention, unlike technologies in the related art, so there is an effect that the structural stability is improved in comparison to the related art.

Accordingly, by using the conductive polymer microfiber mesh structure of the present invention, there is an effect that it is possible to provide an electrode having improved structural stability and suspension stability and there is an effect that it is possible to secure electrochemical characteristics at a predetermined level without deterioration of electrochemical characteristics even in a thick electronic device structure.

An electrode according to another embodiment of the present invention is described.

An electrode according to an embodiment of the present invention may include the conductive polymer microfiber mesh structure.

A flexible electronic device according to another embodiment of the present invention is described.

A flexible electronic device according to an embodiment of the present invention may include the electrode including the conductive polymer microfiber mesh structure according to an embodiment of the present invention.

Due to the characteristics of the configuration described above, an electrode including a conductive polymer microfiber mesh structure of the present invention and a flexible electronic device including the electrode have an effect that they are structurally stable, have high electrical conductivity, and have improved electrical and electrochemical characteristics.

A method of manufacturing a conductive polymer microfiber mesh structure according to another embodiment of the present invention is described.

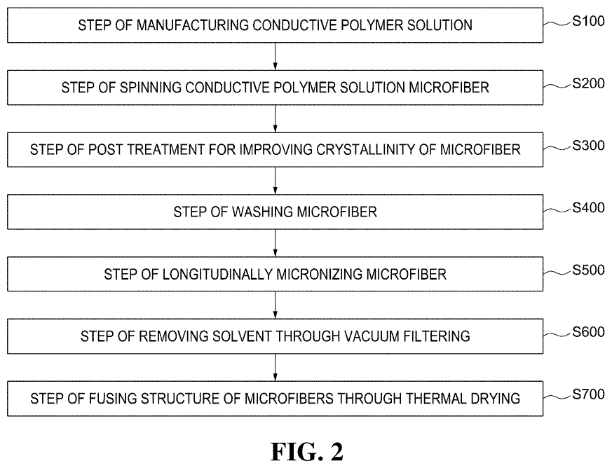

FIG. 2 is a flowchart showing a method of manufacturing a conductive polymer microfiber mesh structure according to an embodiment of the present invention.

Referring to FIG. 2, the method of manufacturing a conductive polymer microfiber mesh structure according to an embodiment of the present invention may include: producing a conductive polymer solution by dissolving a conductive polymer in a solvent (S100); performing wet-spinning on the conductive polymer solution (S200); performing post treatment for improving crystallinity of the wet-spun conductive polymer microfiber (S300); washing the post-treated microfiber with water (S400); forming cylindrical corpuscles by cutting several times the washed microfiber to have a cut surface perpendicular to the longitudinal direction (S500); removing the solvent by filtering the corpuscular conductive polymer microfiber under a vacuum state (S600); and fusing the structure at an intersection of the corpuscles by thermally drying the corpuscular conductive polymer microfiber with the solvent removed (S700).

In this case, the conductive polymer microfiber may be made of a conductive polymer having a pi-orbital.

For example, the conductive polymer having a pi-orbital may include at least any one selected from a group consisting of polyacetylene, polyphenylene, polythiophene, polypyrrole, polyaniline, and poly(3,4-ethylenedioxythiophene). However, the present invention is not limited thereto and the conductive polymer may include any conductive polymer without limitation as long as it is an organic polymer having conductivity capable of conducting electricity and having a conjugation structure in which a C—C bond and a C═C bond alternately exist and thereby having an electrical characteristic by delocalization of electron density of π.

In this case, the solvent may include at least any one selected from a group consisting of water, acetone, ethyl acetate, hexane, ether, chloroform, dichloromethane, and toluene.

In this case, the performing of post treatment for improving crystallinity may include post treatment using a solution containing acid and a polar solvent.

The conductive polymer microfiber is treated with the acid solution, whereby the unnecessary surfactant in the conductive polymer microfiber is removed. Accordingly, the stacking of conductive polymer chains is changed, whereby the degree of crystallinity can be increased. In detail, when the conductive polymer is PEDOT:PSS and when a polymeric composite configured by secondary bonding of the chains of hydrophobic PEDOT and hydrophilic PSS⁻ is treated with acid, some PSS⁻ chains are converted into PSSH (polystyrene sulfonic acid) chains by reacting with protons produced from the acid and the PSSH chains are washed in a washing step, whereby the PSS chains are removed. Accordingly, the PEDOT crystalline structure changes into a crystalline structure having pi-pi stacking and lamella stacking, thereby coming into an advantageous state for crystallization.

Therefore, according to the conductive polymer microfiber mesh structure manufactured in accordance with an embodiment of the present invention, since a mesh shape is formed by structural fusion of conductive polymer microfibers having improved crystallinity even without a specific crosslinking agent, the structure has a characteristic that it is structurally stable.

Due to the characteristics of the configuration described above, in the conductive polymer microfiber mesh structure manufactured in accordance with an embodiment of the present invention, since strong structural fusion occurs at an intersection of microfibers without a specific crosslinking agent by post treatment using a solution containing acid and a polar solvent for improving crystallinity and thermal drying for structural fusion, there is an effect of providing a method of manufacturing conductive polymer microfiber mesh structure having improved structural stability.

Further, due to the characteristics of the configuration described above, since the method of manufacturing conductive polymer microfiber mesh structure according to an embodiment of the present invention uses a conductive polymer having a pi-orbital, there is an effect of providing a method of manufacturing conductive polymer microfiber mesh structure having high electrical conductivity.

Hereafter, the present invention is described in more detail through manufacturing examples, comparative examples, and experimental examples. However, the present invention is not limited to the manufacturing examples and experimental examples.

### <Manufacturing Example 1> Manufacturing of Conductive Polymer Microfiber Mesh Structure

A conductive polymer microfiber mesh structure according to an embodiment of the present invention was manufactured.

To this end, a conductive polymer solution obtained by dissolving poly(3,4-ethylenedioxythiophene) polystyrene sulfonate in water was wet-spun in an acetone coagulation bath. The wet-spun conductive polymer microfiber was treated with sulfuric acid having concentration of 80% to 100% to improve crystallinity and was then washed with water. The manufactured conductive polymer microfiber was cut into corpuscles by cutting it several times perpendicular to the longitudinal direction.

The solvent was removed by performing vacuum filtering on the manufactured corpuscles. A mesh structure in which structures were fused at intersections of conductive polymer microfibers was manufactured by thermally drying the vacuum-filtered corpuscles at 60° C. for sharing crystallinity and fusing structures of the microfibers.

### <Manufacturing Example 2> Manufacture of Electrode Using Conductive Polymer Microfiber Mesh Structure

An electrode using a conductive polymer microfiber mesh structure according to an embodiment of the present invention was manufactured.

To this end, an electrode was manufactured by depositing the conductive polymer microfiber mesh structure manufactured according to the manufacturing example 1 on a glass substrate coated with chrome and gold.

### <Experimental Example 1> Experiment of Measuring Suspension Stability of Electrode Based on Conductive Polymer Microfiber Mesh Structure

An experiment of measuring suspension stability of an electrode using a conductive polymer microfiber mesh structure according to an embodiment of the present invention was performed.

To this end, the conductive polymer microfiber mesh structure manufactured according to the manufacturing example 1 was used.

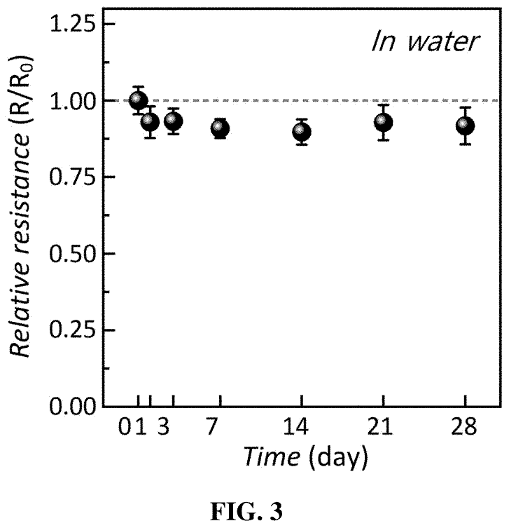

FIG. 3 is a graph showing suspension stability measured over time of an electrode using the conductive polymer microfiber mesh structure according to the manufacturing example 1.

Referring to FIG. 3, it could be seen that the relative resistance of an electrode was relatively uniformly maintained in an electrode using a conductive polymer microfiber mesh structure according to an embodiment of the present invention, so it could be seen that the electrode using a conductive polymer microfiber mesh structure manufactured in accordance with an embodiment of the present invention has high suspension stability.

### <Experimental Example 2> Experiment of Measuring Electrical/Electrochemical Characteristics of Electrode Based on Conductive Polymer Microfiber Mesh Structure

An experiment of measuring a change of electrical/electrochemical characteristics over mass per unit area of an electrode using a conductive polymer microfiber mesh structure according to an embodiment of the present invention was performed.

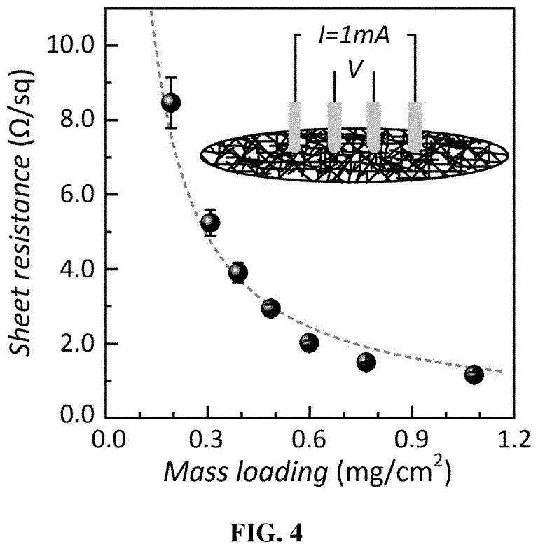

FIG. 4 is a graph showing sheet resistance measured over mass per unit area.

Referring to FIG. 4, it can be seen that the larger the mass per unit area of a conductive polymer microfiber, the smaller the sheet resistance value.

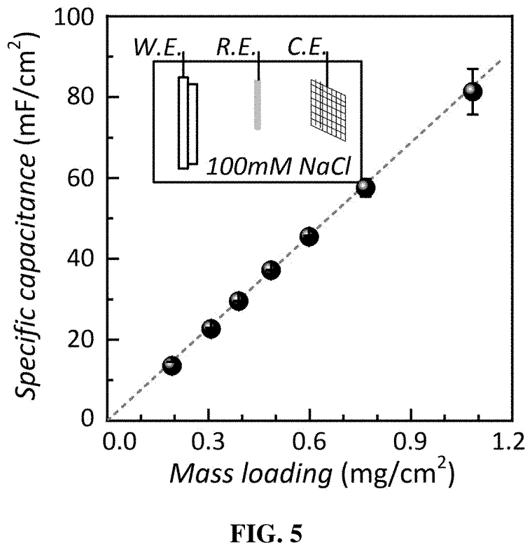

FIG. 5 is a graph showing specific capacitance per unit area measured under a 3-electrorde system.

In this case, a silver/silver chloride standard electrode was used as a reference electrode, a platinum wire-based mesh electrode was used as a counter electrode, and the electrode manufactured according to the manufacturing example 2 was used as working electrode; and specific capacitance was measured in NaCl electrolyte of 100 mM.

Referring to FIG. 5, it can be seen that as the mass per unit area of a conductive polymer microfiber increases, the specific capacitance also increases.

Accordingly, referring to FIGS. 4 and 5, it can be seen that the electrode using a conductive polymer microfiber mesh structure according to an embodiment of the present invention has excellent electrical/electrochemical characteristics in comparison to the related art.

### <Experimental Example 3> Experiment of Measuring Transmittance According to Change of Mass Per Unit Area of Electrode Based on Conductive Polymer Microfiber Mesh Structure

An experiment of measuring transmittance over mass per unit area of an electrode using a conductive polymer microfiber mesh structure according to an embodiment of the present invention was performed.

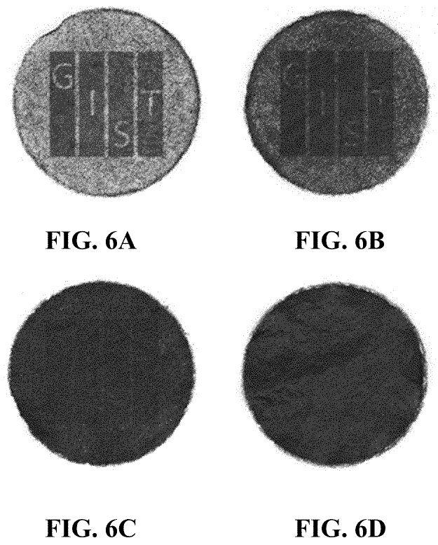

FIGS. 6A-6D are pictures showing a transmittance difference over mass per unit area of an electrode using a conductive polymer microfiber mesh structure according to an embodiment of the present invention.

Referring to FIGS. 6A-6D, it can be seen that it is possible to control the thickness by adjusting the loading amount of a conductive polymer microfiber when manufacturing a conductive polymer microfiber mesh structure, and accordingly, it is possible to control the transmittance.

Therefore, since the conductive polymer microfiber mesh structure according to an embodiment of the present invention can be manufactured to have appropriate elasticity, flexibility, and transmittance by variously controlling the thickness, if necessary, high applicability to a transparent flexible electronic device can be secured.

According to the present invention, it is possible to provide a conductive polymer microfiber mesh structure that has elasticity, flexibility, and transmittance and is structurally stable, and a method of manufacturing the structure.

Further, according to the present invention, it is possible to provide an electrode for a flexible electronic device having excellent electrical/electrochemical characteristics and having improved physical stability and suspension stability on the basis of the conductive polymer microfiber mesh structure.

The effects of the present invention are not limited thereto and it should be understood that the effects include all effects that can be inferred from the configuration of the present invention described in the following specification or claims.

The above description is provided as an exemplary embodiment of the present invention and it should be understood that the present invention may be easily modified in other various ways without changing the spirit or the necessary features of the present invention by those skilled in the art. Therefore, the embodiments described above are only examples and should not be construed as being limitative in all respects. For example, the components described as single parts may be divided and the components described as separate parts may be integrated.

The scope of the present invention is defined by the following claims, and all of changes and modifications obtained from the meaning and range of claims and equivalent concepts should be construed as being included in the scope of the present invention.

### REFERENCE SIGNS LIST

1: intersections
2: conductive polymer microfibers

What is claimed is:

1. A conductive polymer microfiber mesh structure comprising a plurality of conductive polymer microfibers,
wherein any one of the conductive polymer microfibers intersects at least one or more other conductive polymer microfibers, and intersections share crystallinity without a specific crosslinking agent and are structurally fused, whereby a mesh structure is formed.

2. The conductive polymer microfiber mesh structure of claim 1, wherein the crystallinity of the conductive polymer microfiber is improved by post treatment using a solution containing acid and a polar solvent.

3. The conductive polymer microfiber mesh structure of claim 1, wherein the conductive polymer microfiber has a cylindrical corpuscular shape.

4. The conductive polymer microfiber mesh structure of claim 1, wherein conductive polymer microfiber is made of a conductive polymer having a pi-orbital.

5. The conductive polymer microfiber mesh structure of claim 4, wherein the conductive polymer having a pi-orbital includes at least any one selected from a group consisting of polyacetylene, polyphenylene, polythiophene, polypyrrole, polyaniline, and poly(3,4-ethylenedioxythiophene).

6. An electrode comprising the conductive polymer microfiber mesh structure of claim 1.

7. A flexible electrode device comprising the electrode comprising the conductive polymer microfiber mesh structure of claim 1.

8. A method of manufacturing a conductive polymer microfiber mesh structure, comprising:
producing a conductive polymer solution by dissolving a conductive polymer in a solvent;
performing wet-spinning on the conductive polymer solution;
performing post treatment for improving crystallinity of the wet-spun conductive polymer microfiber;
washing the post-treated microfiber with water;
forming cylindrical corpuscles by cutting several times the washed microfiber to have a cut surface perpendicular to the longitudinal direction;
removing the solvent by filtering the corpuscular conductive polymer microfiber under a vacuum state; and
fusing the structure at an intersection of the corpuscles by thermally drying the corpuscular conductive polymer microfiber with the solvent removed,
wherein any one of the conductive polymer microfibers intersects at least one or more other conductive polymer microfibers, and intersections share crystallinity without a specific crosslinking agent and are structurally fused, whereby a mesh structure is formed.

9. The method of claim 8, wherein the conductive polymer is a conductive polymer having a pi-orbital.

10. The method of claim 9, wherein the conductive polymer having a pi-orbital includes at least any one selected from a group consisting of polyacetylene, polyphenylene, polythiophene, polypyrrole, polyaniline, and poly(3,4_ethylenedioxythiophene).

11. The method of claim 8, wherein the solvent includes at least any one selected from a group consisting of water, acetone, ethyl acetate, hexane, ether, chloroform, dichloromethane, and toluene.

12. The method of claim 8, wherein the performing of post treatment for improving crystallinity includes post treatment using a solution containing acid and a polar solvent.
